(19) United States
(12) Patent Application Publication
(10) Pub. No.: US 2011/0140886 A1
(43) Pub. Date: Jun. 16, 2011

(54) EMERGENCY WARNING DEVICE

(75) Inventors: Peter Bettonvil, Kingsley (AU); Greg COOK, Kensington (AU); Andrew HILL, North Fremantle (AU); Simon MCNAMARA, Swan View (AU)

(73) Assignee: Mobilarm Limited, Applecross (AU)

(21) Appl. No.: 12/942,822

(22) Filed: Nov. 9, 2010

(30) Foreign Application Priority Data
Nov. 9, 2009 (AU) 2009905478

(51) Int. Cl. G08B 21/00

(52) U.S. Cl. 340/540

(57) ABSTRACT

An emergency warning device (10) is disclosed which comprises
an overboard detection device (15) arranged to determine when an overboard situation exists, a transmitter (14) for transmitting a warning signal indicative of an overboard situation, and a transmission control sensor (22) arranged to produce transmission control information indicative of whether the device is appropriately disposed for transmission of a warning signal. The device (10) is arranged to transmit the warning signal when an overboard situation is determined and when said transmission control information indicates that the device is appropriately disposed for transmission of a warning signal.

### FIELD OF THE INVENTION

The present invention relates to an emergency warning device and, in particular, to an emergency position locating device.

### BACKGROUND OF THE INVENTION

It is known to provide an emergency warning device in the form of an emergency position locating device which is arranged to transmit an alarm signal, for example including position information indicative of the position of the locating device, when an emergency situation exists. With one such device, the device is arranged to be worn or carried by a person on a marine vessel and to commence transmission of a warning signal when an overboard situation is detected. An overboard situation may be detected using an appropriate sensor on the device, based on proximity to a base station located on the vessel, or in any other way.

However, existing emergency warning devices are relatively unsophisticated in that transmission of a warning signal commences immediately on detection of an overboard situation. As a consequence, the transmission may be inefficient and device power may be wasted.

### SUMMARY OF THE INVENTION

In accordance with an aspect of the present invention, there is provided an emergency warning device comprising:
an overboard detection device arranged to determine when an overboard situation exists;
a transmitter for transmitting a warning signal indicative of an overboard situation; and
a transmission control sensor arranged to produce transmission control information indicative of whether the device is appropriately disposed for transmission of a warning signal;
wherein the device is arranged to transmit the warning signal when an overboard situation is determined and when said transmission control information indicates that the device is appropriately disposed for transmission of a warning signal.

In one embodiment, the transmission control sensor is arranged to produce transmission control information indicative of whether the device is disposed adjacent the surface of a body of water, and the device is arranged to transmit the warning signal when said transmission control information indicates that the device is disposed adjacent the surface of a body of water.

In one embodiment, the transmission control sensor is arranged to produce transmission control information indicative of whether the device is disposed adjacent a crest of a wave or adjacent a trough of a wave, and the device is arranged to transmit the warning signal when said transmission control information indicates that the device is disposed adjacent a crest of a wave.

In one embodiment, the transmission control sensor is arranged to produce transmission control information indicative of the orientation of the device, and the device is arranged to transmit the warning signal when said transmission control information indicates that the device is oriented in a substantially vertical orientation.

In one embodiment, the transmission control sensor comprises a motion sensor arranged to provide information indicative of movement and/or orientation of the device.

In one embodiment, the transmission control sensor comprises an accelerometer.

In one embodiment, the transmission control sensor comprises a pressure sensor arranged to produce transmission control information indicative of the ambient pressure adjacent the device, and the device is arranged to transmit the warning signal when said transmission control information indicates that the ambient pressure is below a predefined level.

In one arrangement, the device comprises a control unit arranged to control and coordinate operations in the device.

In one embodiment, the device comprises a light source arranged to produce a visible warning signal when an overboard situation is determined. The device may further comprise a light sensor arranged to produce information indicative of the ambient light level and the device may be arranged to activate the light source when the ambient light level is below a predefined level. The light sensor may comprise a light dependent resistor.

In one embodiment, the device is arranged to activate the light source when the transmission control signal indicates that the device is disposed adjacent the surface of a body of water.

### BRIEF DESCRIPTION OF THE DRAWINGS

The present invention will now be described, by way of example only with reference to the accompanying drawings, in which:

FIG. 1 is a schematic block diagram of an emergency warning device in accordance with an embodiment of the present invention;

FIG. 2 is a diagrammatic representation illustrating the emergency warning device of FIG. 1 during use.

### DESCRIPTION OF AN EMBODIMENT OF THE INVENTION

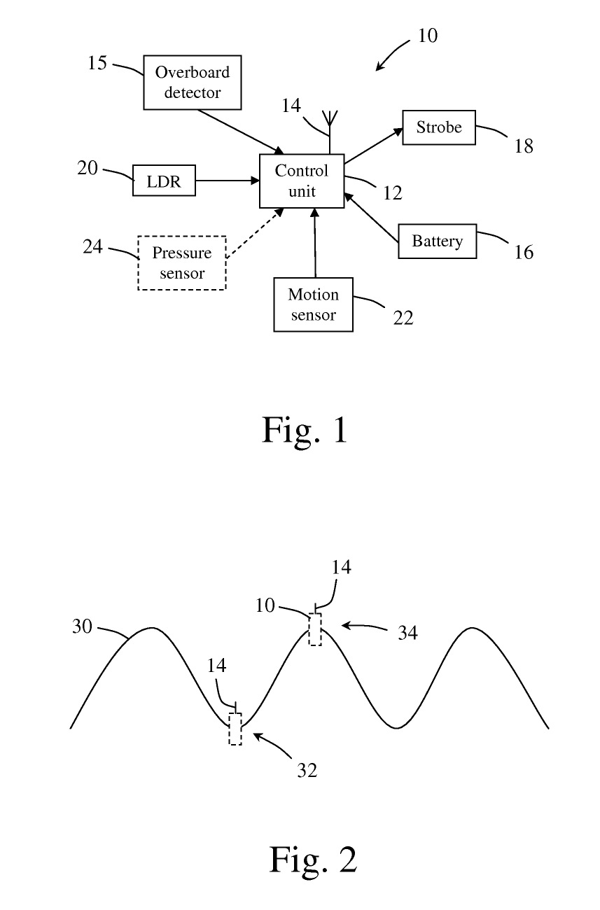

Referring to FIG. 1 of the drawings, there is shown an emergency warning device 10, in this example in the form of an emergency position locating device arranged to transmit a warning signal indicative of the location of the device 10 when an overboard situation is detected.

In the present embodiment, the emergency warning device 10 is for use on a marine vessel and is configured so as to be worn or carried by a person. If the person wearing the device 10 inadvertently falls overboard, the device detects the overboard situation, for example by detecting contact with water, and transmits an emergency signal.

The emergency warning device 10 includes a control unit 12 for controlling and coordinating operations in the device 10, including activation of a transmitter 14 in order to transmit an emergency signal when an overboard situation has been detected by an overboard detection device 15.

The control unit 12 may be of any suitable form and in this example includes a microprocessor and associated memory provided with suitable programs for implementing the required functionality.

The device 10 also includes a battery 16 for providing power to the device 10, a strobe light 18 arranged to generate a pulsating light in response to detection of an overboard situation and, in this example, the device 10 also includes a light sensor 20 in the form of a light dependent resistor (LDR) arranged to sense the ambient light level and generate a light level signal usable by the control unit 12 to determine when to activate the strobe light 18. For example, the control unit may be arranged so as to only activate the strobe light 18 when the ambient light level is below a defined light level threshold. This serves to reduce power usage by preventing activation of the strobe light 18 during the day.

The device 10 also includes a transmission control sensor arranged to provide the control unit 12 with a signal indicative of whether the device 10 is disposed in a position and/or orientation which is suitable for good transmission of a warning signal. In this example, the transmission sensor 22 is in the form of a motion sensor 22 arranged to sense motion of the device and/or orientation of the device. In a particular embodiment, the motion sensor 22 comprises an accelerometer.

In one embodiment, the motion sensor 22 generates a signal indicative of the speed of movement of the device 10 and the control unit 12 is arranged to commence transmission of a warning signal when an overboard situation has been detected and when the speed of movement of the device 10 is below a defined threshold.

In this way, transmission of a warning signal will not commence whilst the device 10 is significantly submerged under the surface of the water and traveling towards the water surface but will commence transmission when the device 10 is on or adjacent the water surface. Accordingly, the efficiency of transmission of the warning signal is maximised because power will not be wasted transmitting a warning signal whilst the device 10 is submerged underneath the water surface.

This arrangement is particularly applicable to submarines wherein persons escaping from a submarine need to travel through a significant amount of water in order to reach the water surface.

The motion information provided by the motion sensor 22 may also be used to determine the orientation of the device 10 or the approximate location of the device 10 relative to a wave 30, as shown in FIG. 2.

For example, as shown in FIG. 2, the device is shown at a first position 32 adjacent a trough of a wave 30 and at a second position 34 adjacent a crest of a wave 30. For clarity purposes, a person associated with the device 10 is not shown. In order to maximise efficiency of transmission of a warning signal, it is better to transmit the warning signal when the device 10 is adjacent a wave crest than adjacent a wave trough. Accordingly, the control unit 12 may be arranged so as to monitor the position of the device 10 relative to a wave 30 using the motion information and thereby cause transmissions to occur when the device 10 is adjacent a wave crest.

The control unit 12 may also be arranged to use the motion signals provided by the motion sensor 22 to determine the approximate orientation of the device 10, and to control transmission of a warning signal depending on the device orientation. This is significant since a better transmission is achieved if the device 10 is disposed in a generally vertical orientation and, accordingly, the control unit 12 may be arranged to transmit a warning signal when the motion sensor 22 indicates that the device 10 is disposed in a generally vertical orientation.

In addition or as an alternative to providing a motion sensor 22, the device 10 may include a pressure sensor 24 arranged to detect the surrounding fluid pressure, with the control unit 12 arranged to cause transmission to commence when the fluid pressure is below a predetermined level indicative that the device 10 is disposed close to the water surface.

However, it will be appreciated that any suitable sensor is envisaged, the important aspect being that the sensor is arranged to provide the control unit 12 with information usable to determine when to transmit a warning signal in order to improve transmission efficiency.

Modifications and variations as would be apparent to a skilled addressee are deemed to be within the scope of the present invention.

1. An emergency warning device comprising:
an overboard detection device arranged to determine when an overboard situation exists;
a transmitter for transmitting a warning signal indicative of an overboard situation; and
a transmission control sensor arranged to produce transmission control information indicative of whether the device is appropriately disposed for transmission of a warning signal;
wherein the device is arranged to transmit the warning signal when an overboard situation is determined and when said transmission control information indicates that the device is appropriately disposed for transmission of a warning signal.

2. An emergency warning device as claimed in claim 1, wherein the transmission control sensor comprises a motion sensor arranged to provide information indicative of movement and/or orientation of the device.

3. An emergency warning device as claimed in claim 2, wherein the transmission control sensor comprises an accelerometer.

4. An emergency warning device as claimed in claim 1, wherein the transmission control sensor is arranged to produce transmission control information indicative of whether the device is disposed adjacent the surface of a body of water.

5. An emergency warning device as claimed in claim 4, wherein the device is arranged to transmit the warning signal when said transmission control information indicates that the device is disposed adjacent the surface of a body of water.

6. An emergency warning device as claimed in claim 1, wherein the transmission control sensor is arranged to produce transmission control information indicative of whether the device is disposed adjacent a crest of a wave or adjacent a trough of a wave.

7. An emergency warning device as claimed in claim 6, wherein the device is arranged to transmit the warning signal when said transmission control information indicates that the device is disposed adjacent a crest of a wave.

8. An emergency warning device as claimed in claim 1, wherein the transmission control sensor is arranged to produce transmission control information indicative of the orientation of the device.

9. An emergency warning device as claimed in claim 8, wherein the device is arranged to transmit the warning signal when said transmission control information indicates that the device is oriented in a substantially vertical orientation.

10. An emergency warning device as claimed in claim 1, wherein the transmission control sensor comprises a pressure sensor arranged to produce transmission control information indicative of the ambient pressure adjacent the device.

11. An emergency warning device as claimed in claim 10, wherein the device is arranged to transmit the warning signal when said transmission control information indicates that the ambient pressure is below a predefined level.

12. An emergency warning device as claimed in claim 1, comprising a light source arranged to produce a visible warning signal when an overboard situation is determined.

13. An emergency warning device as claimed in claim 1, comprising a light sensor arranged to produce information indicative of the ambient light level and the device is arranged to activate the light source when the ambient light level is below a predefined level.

14. An emergency warning device as claimed in claim 13, wherein the device is arranged to activate the light source when the transmission control signal indicates that the device is disposed adjacent the surface of a body of water.

15. An emergency warning device as claimed in claim 13, wherein the light sensor comprises a light dependent resistor.
